(19) United States
(12) Patent Application Publication
(10) Pub. No.: US 2014/0091655 A1
(43) Pub. Date: Apr. 3, 2014

(54) Bus Bar for Use in Electric Motor

(71) Applicant: Hayashi Industry Co., Ltd., Nakatsugawa-City (JP)

(72) Inventors: Ko Kajita, Nakatsugawa-City (JP); Takahiko Hobo, Nakatsugawa-City (JP)

(73) Assignee: Hayashi Industry Co., Ltd., Nakatsugawa-City (JP)

(21) Appl. No.: 14/026,683

(22) Filed: Sep. 13, 2013

Related U.S. Application Data
(63) Continuation of application No. PCT/JP2012/006220, filed on Sep. 28, 2012.

(51) Int. Cl. H02K 5/22

(52) U.S. Cl. CPC H02K 5/225
USPC 310/71

(57) ABSTRACT

A bus bar that can be manufactured easily as a part of an electric motor and, as a result, enables manufacturing the electric motor easily and inexpensively. The bus bar is configured to supply power to a plurality of coils of an electric motor and/or ground the coils in assemblage, in which a plurality of folded portions each of which includes three or a larger odd number of overlapping portions are formed on a conductor material having a predetermined length. The bus bar enables forming an insertion space at a predetermined position of each of the folded portions in which a terminal of each of the coils can be inserted so that each of the terminals is inserted into this insertion space and fixed in order to be electrically and directly fixed to the bus bar.

### CROSS-REFERENCE TO RELATED APPLICATIONS

This application is a continuation application of Patent Cooperation Treaty Application No. JP/2012/006220, entitled “Bus Bar for Use in Electric Motor”, filed on Sep. 28, 2012, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to a bus bar referred to as a bus line or bus ring and, more particularly, to a bus bar suitable for use as a component part of an electric motor.

2. Description of Related Art

Also referred to as a bus line, a bus bar is used in condition where many terminals are electrically connected to this single bus bar, to eliminate the need of wiring for each of the terminals. This kind of bus bar has been found useful, for example, in a case where it is necessary to connect the terminals of many coils at the same potential as in the case of an electric motor for use in an oil pump configured to supply pressure oil to the power steering of a vehicle.

In particular, the electric motor for use in the vehicle has been demanded to be small or thin so that the vehicle may not be heavier and the electric motor can be housed in a limited housing space; therefore, this kind of bus bar used as a part of the electric motor has also been demanded to be structured or functional so that the electric motor may be small or thin as a whole. Of course, the bus bar required to electrically connect many coil terminals needs to stably provide secure electrical connection for long. Naturally, to use a motor as an industrial product, this kind of bus bar has also been demanded to facilitate motor production and electrical connection as well as a reduction in costs of the motor.

This kind of bus bar has been demanded to meet those requirements, various solutions for the requirements have thus been proposed in Japanese patent publications JP 2011-254629 A (“Patent Document 1”) and JP 4697597 B2 (Patent Document 2).

The “power distribution structure component and manufacturing method thereof” described in Patent Document 1 aims at solving a problem in that “security of insulation of a power distribution member causes an increase in size of the power distribution structure component”; as shown in FIGS. 13 to 16, the power distribution structure component is “a structure component of a motor given by integrating a plurality of layered power distribution members by insert molding and has a plurality of first insulating holders that are insulators and hold the plurality of power distribution members alternately and a second insulating holder that is an insulator and holds the power distribution members other than those held by the first insulating holders.”

The motor described in Patent Document 1 is a so-called 3-phase AC induction motor, which is of one type targeted by the present invention. Therefore, the bus bars shown in Patent Document 1 are used in 4 kinds of U-phase, V-phase, W-phase, and neutral-phase as shown in FIG. 13 and integrated by the insulating holder as shown in FIG. 15. Those integrated components are assembled as one component of the 3-phase AC induction motor.

The “power distribution member” referred to in Patent Document 1 is considered to be a bus bar targeted by the present invention, which bus bar is of a structure that a “(U-phase) tab 5” to which the terminal of each coil is to be connected must be attached independently or punched out along with the bus bar as shown in FIG. 14. It is thought that to attach the tab to the bus bar independently, the corresponding work or process may be necessary, and to punch out each tab along with the bus bar, a material may be wasted abundantly.

Further, in the case of the “power distribution structure component” described in Patent Document 1, as shown in FIG. 16, the coil terminal must be connected to, for example, a tab 6 of a V-phase bus 61, so that the tab projects from a mold resin 120 to the outside in structure. It is considered not to be so easy to contain the V-layer bus 61 in the resin by molding while permitting the tab 6 to project to the outside.

The “bus bar and motor” described in Patent Document 2 is “to prevent a connecting part and a circuit board from being broken by preventing the generation of stress at the connecting part between a metal member such as a pin in a connector and the circuit board, in a bus bar of an electric motor”, so that, as described in, for example, paragraph 0027 in Patent Document 2, “in a bus bar 50, each connector pin 513 is roughly J-shaped and has two ends 513a and 513b thereof exposed upward from a resin body 51”.

Therefore, in the case of the “bus bar” described in Patent Document 2 also, like that in Patent Document 1, it is necessary but not so easy to contain the bus bar 50 in the resin by molding while permitting the two ends 513a and 513b to project to the outside.

As recent motor coils, a conductor referred to as a “rectangular wire” has been employed. The “rectangular wire” includes a copper wire having a thickness-to-width ratio of 1:2 to 1:20 and an insulating film formed on a surface thereof and can provide a coil with the number of turns and impedance value to be very small and, therefore, has been used as a motor constituent material actively.

Despite those merits, the high thickness-to-width ratio of 1:2 to 1:20 of the “rectangular wire” makes it easy to bend the rectangular wire in the width direction but difficult to bend the rectangular wire in the thickness direction, of course. If such a rectangular wire is wound as a winding wire into a coil and an end thereof is used as a connection terminal as it is, it may not be connected easily owing to its difficulty in thickness-directional bending in some cases. In other words, the rectangular wire has a limitation in direction of bending in which the rectangular wire can be bent only in a certain direction.

If an electric motor in which the bus bar described above is used as a part of components thereof is employed for use in a vehicle, naturally vibration is directly transmitted to the electric motor from the vehicle. The transmitted vibration may have a bad influence in which, in particular, electrical connection portions of the electric motor may be disconnected or peeled off.

### BRIEF SUMMARY OF THE INVENTION

In view of the above, the present invention has been developed to be a part of an electric motor and to enable directly and electrically connecting a coil-side terminal and to manufacture the electric motor easily and inexpensively while stabilizing the relevant electrical connection portions always to inhibit occurrence of the problems of disconnection and peel-off.

That is, it is a first object of the invention to provide a bus bar that can be manufactured easily as a part of an electric motor and, as a result, enables manufacturing the electric motor also easily and inexpensively.

It is a second object of the invention, in addition to the first object to be achieved, to provide a bus bar that enables directly and electrically connecting a coil-side terminal and manufacturing an electric motor easily and inexpensively while stabilizing the relevant electrical connection portions always to inhibit occurrence of problems of disconnection and peel-off.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is an exploded perspective view of a state where a bus bar 10 according to the present invention is attached to a housing of an electric motor via an insulating holder 14.

FIG. 2 is an enlarged cross-sectional view of the insulating holder 14 and each bus bar 10 housed in a hold groove 14a of the insulating holder 14 taken along line 1-1 of FIG. 1.

FIG. 3 is an exploded perspective view of a state where the bus bar 10 is attached to the housing of the electric motor via a mold resin 15.

FIG. 4 is an enlarged cross-sectional view of the mold resin 15 and each bus bar 10 integrated into the mold resin 15 along line 2-2 of FIG. 3.

FIG. 5 shows the bus bar 10 formed by using a wire rod; FIG. 5(a) is a partially-enlarged view thereof and FIG. 5(b) is a further enlarged view of FIG. 5(a).

FIG. 6 is a perspective view showing the bus bar 10 formed by using a flat material.

FIG. 7 shows the bus bar 10 shown in FIG. 6 in a different angle; FIG. 7(a) is a partially-enlarged view thereof and FIG. 7(b) is a further partially-enlarged view of FIG. 7(a).

FIG. 8 is a partially-enlarged plan view of the bus bar 10 showing another embodiment of each folded portion 12.

FIG. 9 is a perspective view showing the bus bar 10 that is formed by using a flat material and has a twisted portion 13 formed on a portion thereof.

FIG. 10 is partially-enlarged perspective views of examples of a conductor material 11 used to form the bus bar 10; FIGS. 10(a), 10(b), and 10(c) show a simple wire rod, a flat material, and a flat block, respectively.

FIG. 11 is a perspective view showing a state where the bus bar 10 formed by using a flat material is enveloped in an insulating tube 16.

FIG. 12 is an exploded perspective view showing a state where the bus bar 10 enveloped in the insulating tube 16 is directly attached to a housing of an electric motor.

FIG. 13 is a conceptual diagram of a 3-phase AC electric motor described in Patent Document 1.

FIG. 14 is a plan view of a bus bar employed in Patent Document 1.

FIG. 15 is another plan view of the bus bar employed in Patent Document 1.

FIG. 16 is an enlarged vertical cross-sectional view of the bus bar employed in Patent Document 1.

FIG. 17 is an enlarged vertical cross-sectional view of a bus bar employed in Patent Document 2.

### DETAILED DESCRIPTION OF THE INVENTION

Means employed in the present invention to solve the problems will be described as follows by using the same reference numerals and symbols as those used in the later-described best mode: “a bus bar 10 for use in an electric motor configured to supply power to a plurality of coils 20 of the electric motor and/or ground the coils 20 in assemblage, in which a plurality of folded portions 12 each of which includes 3 or a larger odd number of overlapping portions 12a are formed on a conductor material 11 having a predetermined length so that at least a terminal 21 of each of the coils 20 can be electrically and directly fixed to a predetermined position of each of the folded portions 12”.

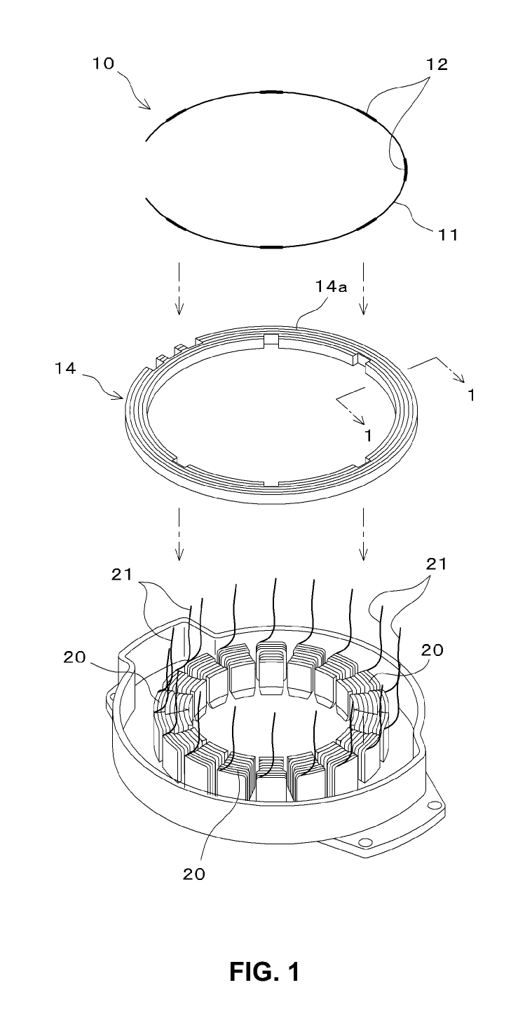

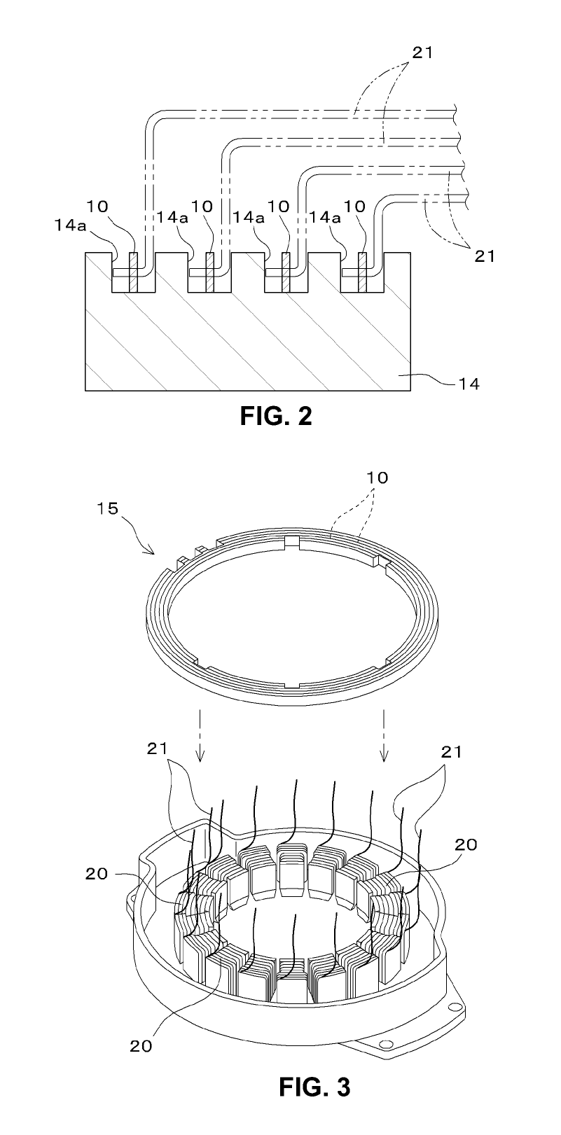

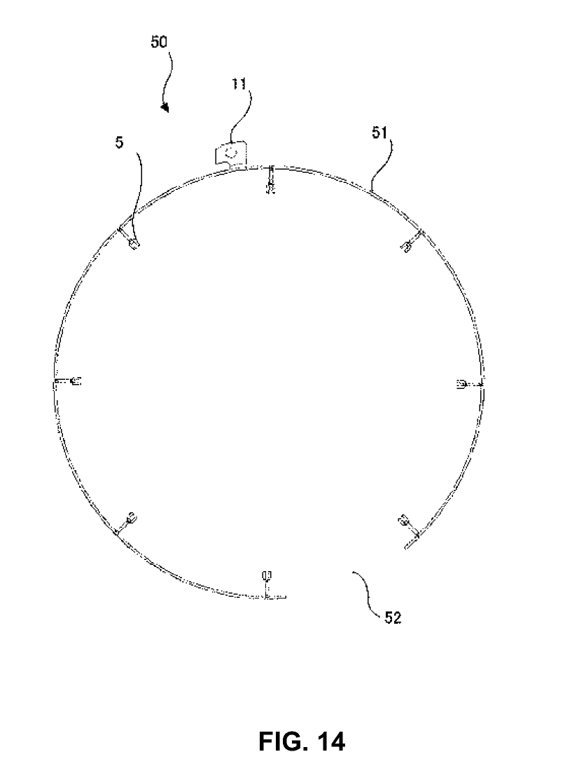

That is, in the case shown in FIG. 1, the bus bar 10 according to a first aspect of the present invention is housed and fixed in each of hold grooves 14a in an insulating holder 14 in condition where each of the terminals 21 of the plurality of coils 20 incorporated in a casing of the electric motor is electrically connected to the bus bar 10, and used by attaching the insulating holder 14 to a housing of the electric motor. As shown in FIG. 2, each of the bus bars 10 shown in FIG. 1 never has a connection terminal such as that of a conventional example shown in FIG. 14; instead, the terminal 21 of each of the coils 20 is directly and electrically connected to the bus bar 10 and then housed and fixed in each of the hold grooves 14a in the insulating holder 14.

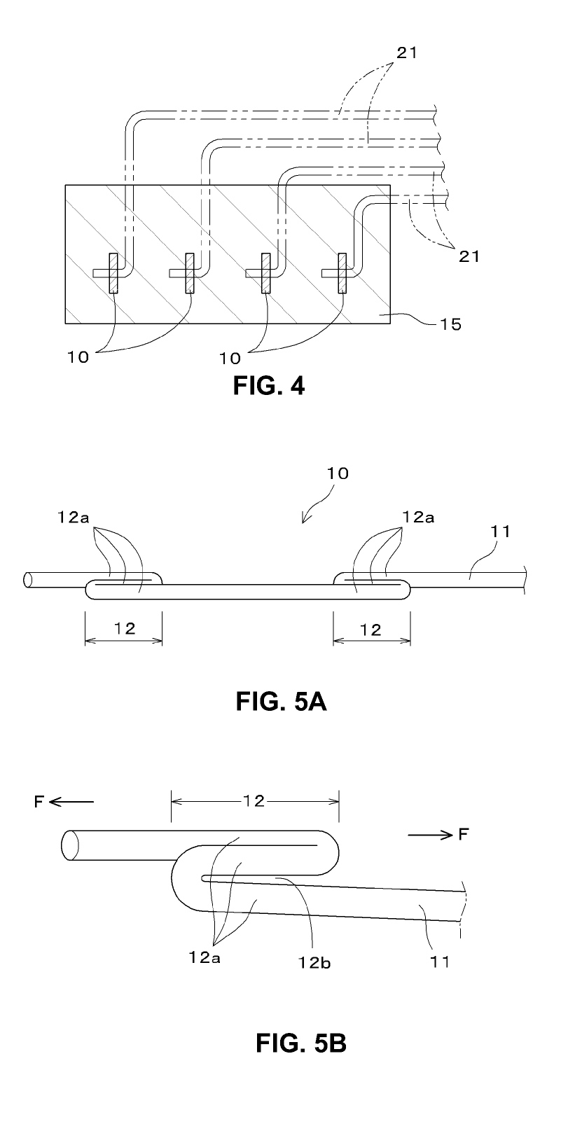

Further, in the case shown in FIG. 3, the bus bar 10 is contained in a mold resin 15 by molding in condition where the bus bar 10 is electrically connected to each of the terminals 21 of the plurality of coils 20 incorporated in the casing of the electric motor. As shown in FIG. 4, each of the bus bars 10 shown in FIG. 3 also never has the connection terminal such as that of the conventional example shown in FIG. 14; instead, before this bar is contained in the mold resin 15 by molding, the terminal 21 of each of the coils 20 is directly and electrically connected to the bus bar 10.

Of course, the bus bar 10 shown in FIG. 1 as well as the bus bar 10 shown in FIG. 3 are both configured to be electrically connected to the terminals 21 of the coils 20 arranged on a circle, so that they are each annular in shape like the conventional example shown in FIG. 14; however, they are each cut at a position to prevent short-circuiting.

As shown in FIGS. 5 to 8, each of the bus bars 10 includes the conductor material 11 made of conductive metal represented by copper and a plurality of folded portions 12 formed at a portion of the conductor material 11, which conductor material 11 is a so-called “wire rod” and not formed by, for example, punching a plate material. The conductor material 11 for making up each bus bar 10 is a material to be wound around a reel, and is rewound as forming the folded portion 12 at a predetermined position on the conductor material 11 and cut off at a predetermined length, thereby making each bus bar 10.

Each of the folded portion 12 includes a plurality of overlapping portions 12a formed by repeatedly folding back the conductor material 11 at a position thereof, as shown in FIGS. 5(a) and 5(b), for example. The overlapping portions 12a are formed by simply folding back the conductor material 11 and, therefore, not fixed to each other, though they overlap with each other. The conductor material 11 is plastically deformed at a portion thereof beyond an elastic limit point or yield point where the conductor material 11 is folded completely, i.e., the conductor material 11 is bent at 180° and, at the other portions, elastically deformed.

Accordingly, as shown in FIG. 5(b), by applying opposite-directional forces to the respective two sides of the folded portion 12 where the mutually overlapping portions 12a are formed, a gap occurs where the overlapping portions 12a are not plastically deformed and can be used as an insertion space which can be used to connect the terminals 21 of the coils 20 electrically and directly. However, when the opposite-directional forces are removed, the gap disappears because the conductor material 11, which is made of metal, is elastically deformed back to its original state by its own elastic force, as shown in FIG. 5(a).

The fact that the overlapping portions 12a can each be elastically deformed means that the overlapping portions 12a where the terminals 21 of the coils 20 are not fixed to each other absorb vibrations received from, for example, a vehicle and, after absorption, immediately recover to their original positions. Therefore, the folded portions 12 itself of the bus bar 10 can each exert an important “vibration absorbing function” for preventing disconnection and peel-off from occurring at the electric connection portions of the terminals 21 of the coils 20.

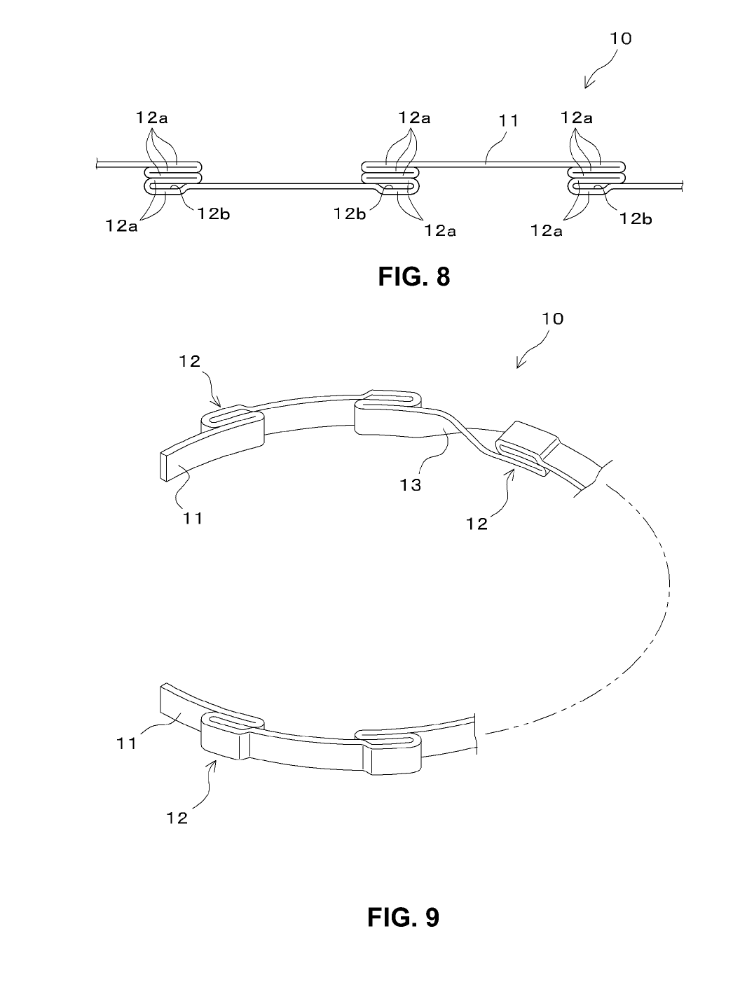

In the bus bar 10 shown in FIG. 5, 6, or 7, each folded portion 12 is made up of the overlapping 3-layer portions 12a; however, the number of the layers of the overlapping portions 12a may be 5, as shown in FIG. 8. Of course, the number of the layers of the overlapping portions 12a may be 7 or a larger odd number as far as a space can be reserved to store them. The 3 or the larger odd number of layers are required to form the overlapping portions 12, because each folded portion 12 of the bus bar 10 needs to have at least 3 portions in a length direction of the conductor material 11, that is, the forward traveling first overlapping portion 12a, the backward traveling next overlapping portion 12a, and the originally-directional traveling overlapping portion 12a, and further, if any more are required, each couple of the overlapping portions 12a are added in this order, that is, the forward traveling overlapping portion 12a and the backward traveling overlapping portion 12a so that they can be formed sequentially following one elongated insulating film 11a in an extending direction thereof.

Further, the conductor material 11 is “bare” without having the later-described insulating film 11a, so that even if the overlapping portions 12a overlap to come in contact with each other at the folded portion 12, the bus bar 10 does not short-circuit. This is because the bus bar 10 is energized everywhere thereon to produce the same potential at the folded portions 12.

Of course, it is only necessary to form at least the 3 overlapping portions 12a of the folded portion 12 from the long conductor material 11 in a length direction thereof, that is, the forward traveling first overlapping portion 12a, the backward traveling next overlapping portion 12a, and the originally-directional traveling overlapping portion 12a; therefore, the conductor material 11 can be mechanically easily bent in the length direction thereof, so that the bus bar 10 can be manufactured simply and inexpensively.

The terminals 21 of the coils 20 are electrically connected to the bus bar 10 formed as described above by making them abut against any one of the overlapping portions 12a of the folded portion 12, or inserting them into the insertion space formed between the 2 overlapping portions 12a, so that they may undergo “spot welding”, or make them undergo “musing caulking” (process to heat partially with a large current for pressing). By conducting such treatment, the terminals 21 of the coils 20 can be directly and electrically connected to the bus bar 10 without requiring a “tab 5” such as that shown in FIG. 14.

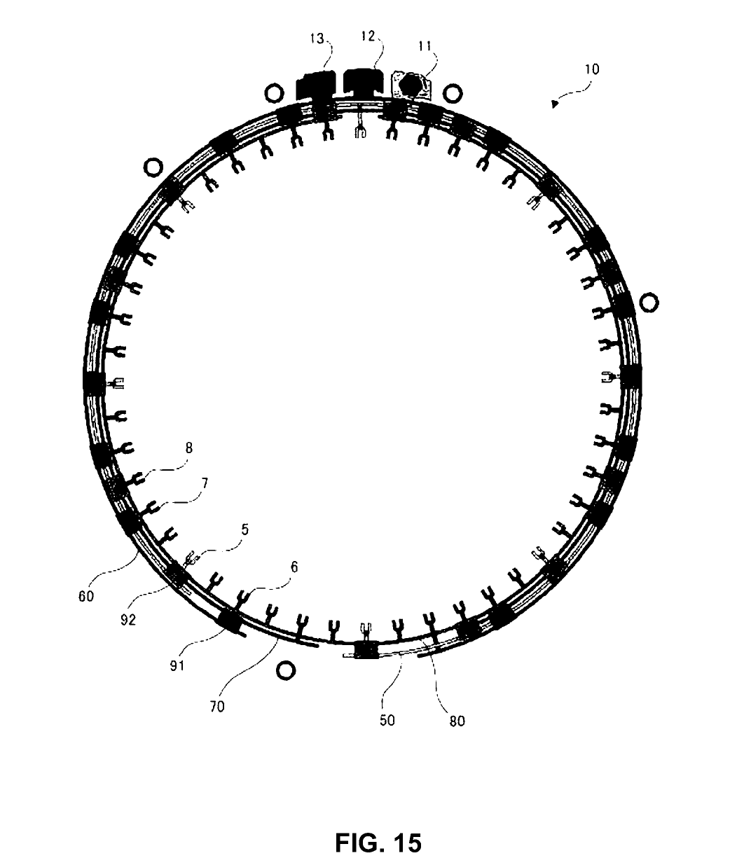

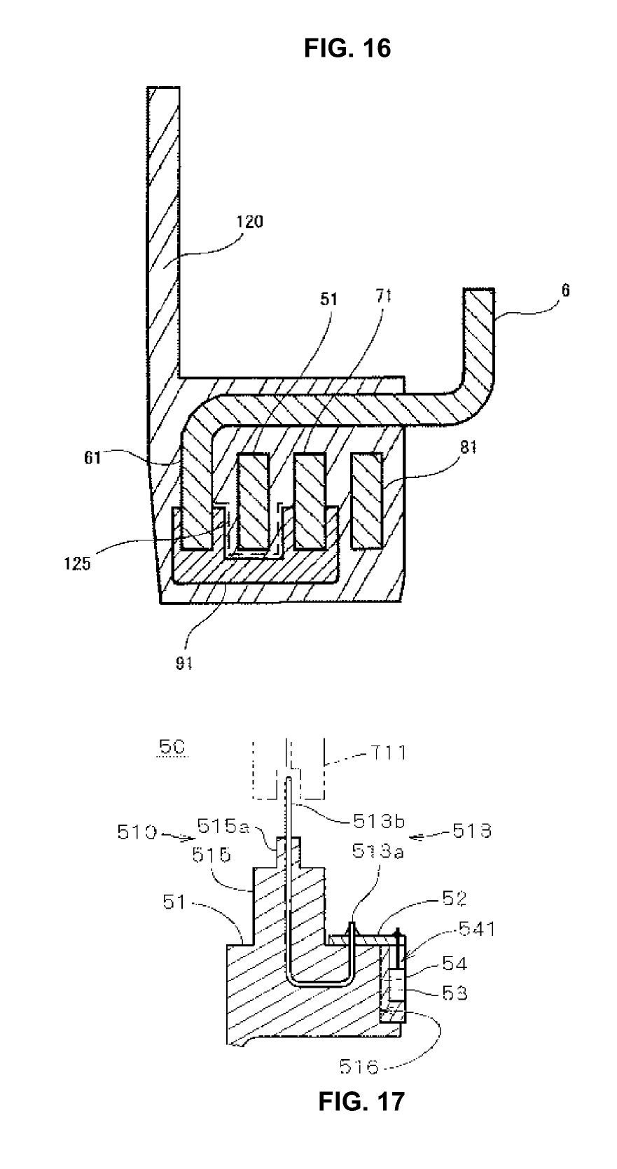

Consequently, the bus bar 10 eliminates the need of forming a tab on the terminal 21 of each coil 20 so that the terminals 21 of the coils 20 can be directly and electrically connected to the bus bar 10, overall enabling manufacturing an electric motor easily and inexpensively. Of course, if used in a 3-phase electric motor, the plurality of (4, for example) bus bars 10 are arranged in the same plane in a manner that they may not come in contact with each other as in the case of the conventional technology example shown in FIG. 15, and if contained in the mold resin 15 by molding, an insulating spacer is interposed between the bus bars 10.

Further, the thickness of the bus bar 10 orthogonal to torus thereof is basically set equal to the thickness or width of the conductor material 11 of this bus bar 10 as shown in FIGS. 5 to 8, which means that it is only necessary to preset the depth of the hold groove 14a in the insulating holder 14 or the thickness of the mold resin 15 a little larger than the thickness or width of the conductor material 11. As a result, an electric motor formed by employing the bus bar 10 can be reduced in size or thickness.

Therefore, the bus bar 10 according to the first aspect of the present invention can be easily manufactured as a part of the electric motor, to resultantly enable the manufacturing of the electric motor also easily and inexpensively.

To solve the problems, means employed by an invention according to a second aspect of the present invention is the bus bar 10 for use in the electric motor according to the first aspect of the present invention, in which “the insertion space 12b in which the terminal 21 of the coil 20 can be inserted is formed in at least one of the odd number of overlapping portions 12a”.

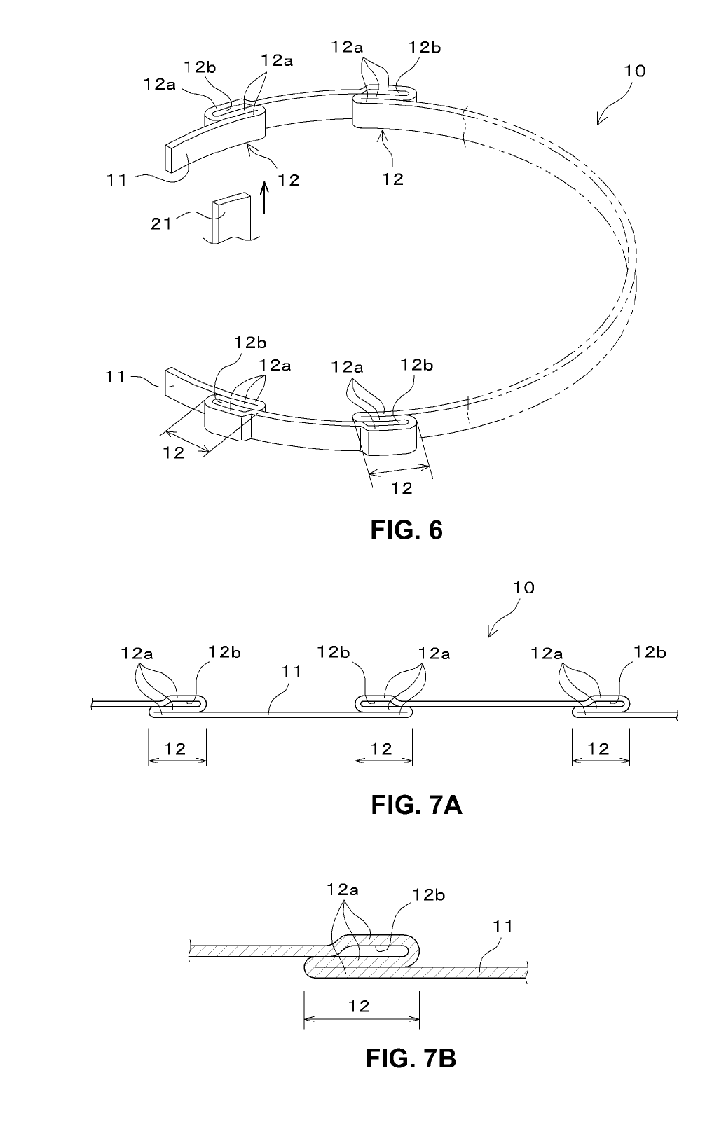

On the bus bar 10 according to the second aspect of the present invention, as shown in FIGS. 6 to 9, the insertion space 12b, which is formed in at least one of the overlapping portions 12a of the folded portion 12, is arranged to enable inserting the terminal 21 of the coil 20 thereinto as indicated by an arrow in FIG. 6. Such an insertion space 12b enables carrying out connection work more easily because the insertion space 12b eliminates the need of purposely forming the gap such as that shown in FIG. 5(b) at each of the folded portions 12.

The insertion space 12b can be easily formed by forming a portion corresponding to the insertion space 12b at a portion of a mold used to bend and form each of the overlapping portions 12a of the folded portions 12, without using a large-scale technology in particular.

Therefore, in addition to the same functions as those exerted by the first aspect of the present invention, the bus bar 10 of the second aspect of the present invention has a function to enable inserting the terminal 21 of the coil 20 into the insertion space 12b, thereby further facilitating work of connecting the terminals 21 of the coils 20 to each of the bus bars 10.

To solve the problems, means employed by an invention according to a third aspect of the present invention is the bus bar 10 for use in the electric motor according to the first or second aspect of the present invention, in which “at least one twisted portion 13 is formed on the conductor material 11 between the folded portions 12 and an opening direction of the insertion space in one of the two folded portions 12 adjacent to this twisted portion 13 on both sides is changed with respect to that of the insertion space in the other folded portion 12 adjacent to this twisted portion 13”.

The terminal 21 of each coil 20, which is pulled out toward the bus bar 10 as shown in FIGS. 1 and 3, is inserted into the insertion space in each of the folded portions 12 of the bus bar 10 according to the invention, no matter whether it is just the space such as that shown in FIG. 5(b) or the insertion space 12b formed actively such as shown in FIG. 6, etc., and then electrically connected by spot welding, etc.; however, the direction of the insertion space may not match the direction of the terminal 21 of the coil 20 in some cases. Further, sometimes, the wire rod of the terminal 21 of the coil 20 may have a limitation in bending direction as in the case of the “rectangular wire” described above. To accommodate those cases, the bus bar 10 of the third aspect of the present invention is made it possible to change the direction of the insertion space in one of the folded portions 12 with respect to that of the insertion space in the other folded portion 12 via the twisted portion 13.

Of course, the twisting angle of each of the twisted portions 13 is selected appropriately; however, naturally it is not 180° or more because the twisted portion 13 is used to change the direction of the insertion space in order to facilitate insertion of the terminal 21 into the insertion space in each folded portion 12.

Therefore, besides almost the same functions as those of the first or second aspect of the present invention, the bus bar 10 of the third aspect of the present invention has a function to facilitate insertion of each terminal 21 by changing the directions of the insertion spaces on the two sides of the twisted portion 13 by having the twisted portion 13 formed on the conductor material 11.

To solve the problems, means employed by an invention according to a fourth aspect of the present invention is the bus bar 10 for use in the electric motor according to any of the first to third aspects of the present invention, in which “the conductor material 11 is a flat material having a width-to-thickness ratio of 2:1 to 20:1 and each of the overlapping portions 12a is given by folding this flat material at a width-directional kinked line thereof”.

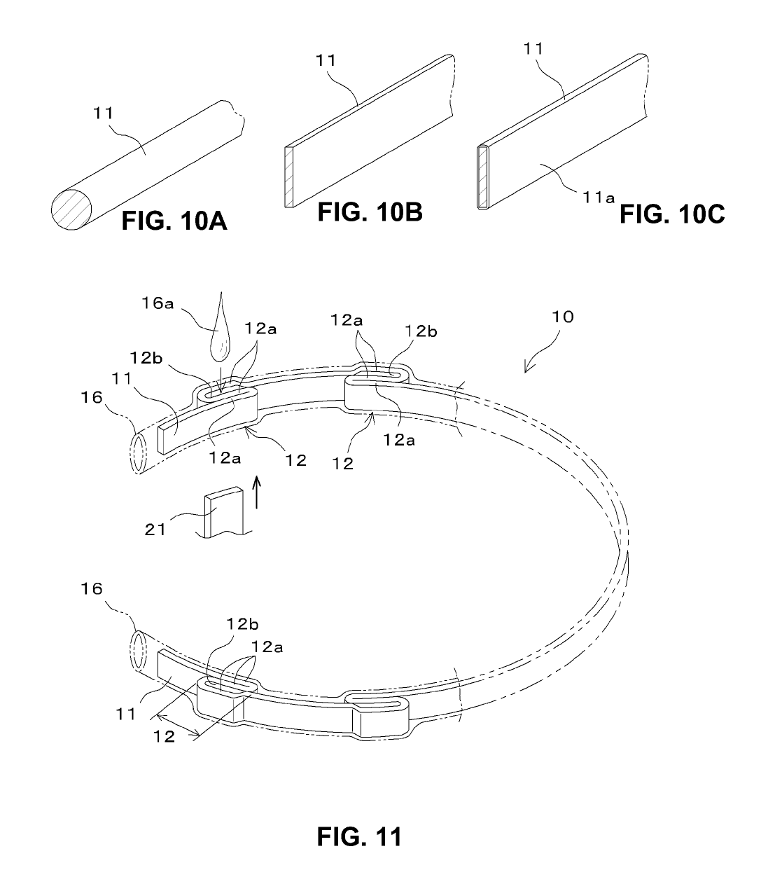

That is, the bus bar 10 of the fourth aspect of the present invention is overall formed using the conductor material 11 made of the flat material such as that shown in FIG. 10(b) or 10(c) having the width-to-thickness ratio of 2:1 to 20:1, as shown in FIGS. 6 to 9. In other words, the bus bar 10 of the fourth aspect of the present invention is formed as shown in, for example, FIG. 6 by using a wire rod such as that shown in FIG. 10(a) rather than a round wire rod such as that shown in FIG. 5, thereby effectively utilizing merits as the flat material.

The flat material such as that shown in FIG. 10(b) or 10(c) is different from a wire rod such as that shown in FIG. 10(a) in that the flat material has a demerit of extreme difficulty in thickness-directional bending, but has a merit of having a sufficient area to facilitate direct electrical connection and reduce impedance during energization more than the wire rod.

The flat material needs to have the width-to-thickness ratio of 2:1 to 20:1 because if the ratio is less than 2:1, this material is like a wire rod and does not have sufficient merits as a flat material. If the ratio is larger than 20:1, this material is like a flat plate and needs to have a larger sized processing machine in order to cut off excess thereof and form the folded portions 12 and does not have sufficient merits as a flat material in this case either.

By forming the bus bar 10 overall by using the conductor material 11 that is such a flat material, it becomes easy to bend the bus bar 10 in the width direction, that is, form the folded portions 12 or form the bus bar 10 in an annular shape. In particular, the overlapping portions 12a of each folded portion 12 can be easily folded at a width-directional kinked line of the flat material to form each folded portion 12 very stably. In other words, the kinked line resulting from folding of the flat material faces a direction in which the flat material can be bent most easily, that is, a direction orthogonal to the length direction thereof.

If the flat material is folded at a width-directional kinked line, that is, a kinked line orthogonal to the length direction thereof as described above, the overlapping portions 12a of the folded portion 12 overlap with each other literally completely as shown in FIGS. 6 to 9. In other words, by forming the bus bar 10 by folding the flat material at the width-directional kinked line thereof, the bus bar 10 has almost the same width-directional size as that of the original flat material, to remain narrow in a manner.

Therefore, besides almost the same functions as those of the first to third aspects of the present invention, the bus bar 10 of the fourth aspect of the present invention keeps its width unchanged at all even after the processing of the folded portions 12, thereby facilitating designing of the insulating holder 14 and the mold resin 15.

To solve the problems, means employed by an invention according to a fifth aspect of the present invention is the bus bar 10 for use in the electric motor according to any of the first to fourth aspects of the present invention, in which “the conductor material 11 is a flat block on a surface of which the insulating film 11a is formed”.

That is, as shown in FIGS. 6 to 9, the bus bar 10 of the fifth aspect of the present invention is overall formed using the conductor material 11 that is the flat block on the surface of which the insulating film 11a is formed such as that shown in FIG. 10(c). In other words, the bus bar 10 of the fifth aspect of the present invention is not formed as shown in FIG. 5 by using a wire rod such as that shown in FIG. 10(a), thereby effectively utilizing merits as the flat block on which the insulating film 11a is formed.

Such a conductor material 11 that is the flat block on the surface of which the insulating film 11a is formed is commercially available generally and can make up a coil with very few turns and low impedance and, therefore, has been actively used as a motor constituent material. Like the flat material according to the fourth aspect of the present invention, the conductive material 11 that is the flat block has a demerit of extreme difficulty in thickness-directional bending unlike the wire rod such as that shown in FIG. 10(a) but has a merit of having a sufficient area to facilitate direct electrical connection and reduce impedance during energization more than the wire rod.

Of course, the bus bar 10, which is formed using this conductor material 11 that is the flat block, has the insulating film 11a on the surface thereof and, therefore, needs not take into consideration possible subsequent short-circuiting when the bus bar 10 is incorporated into the holder groove 14a in the insulating holder 14 shown in FIGS. 1 and 2 or contained by molding in the mold resin 15 shown in FIGS. 3 and 4. Needless to say, of course, each bus bar 10 completed is automatically insulated with the insulating film 11a on the surface thereof.

Further, if the insulating film 11a is formed with a thin film such as a so-called enamel material (as in the case of commercially available rectangular wires), there occurs no problem when electrically and directly connecting the terminals 21 of the coils 20 to each folded portion 12 by “spot welding” or “musing caulking”, because the insulating film 11a is removed by heat.

Further, the conductor material 11 having the insulating film 11a formed on the flat block is generally inexpensive and commercially available, while the overlapping portions 12a of each folded portion 12 can be formed by folding without projecting the overlapping portions 12a in the width direction of the conductor material 11 as in the case of the fourth aspect of the present invention, so that it is possible to manufacture the bus bar 10 easily and inexpensively.

Therefore, besides almost the same functions as those of the first to fourth aspects of the present invention, the bus bar 10 according to the fifth aspect of the present invention itself has insulation properties due to the insulating film 11a and can be

To solve the problems, means employed by an invention according to a sixth aspect of the present invention is the bus bar 10 for use in the electric motor according to any of the first to fifth aspects of the present invention, in which “the conductor material 11 on which the folded portion 12 is formed is inserted into an insulating tube 16”.

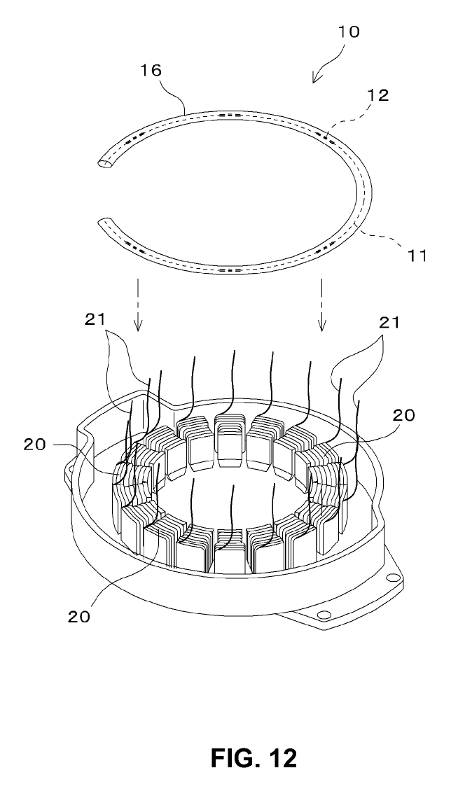

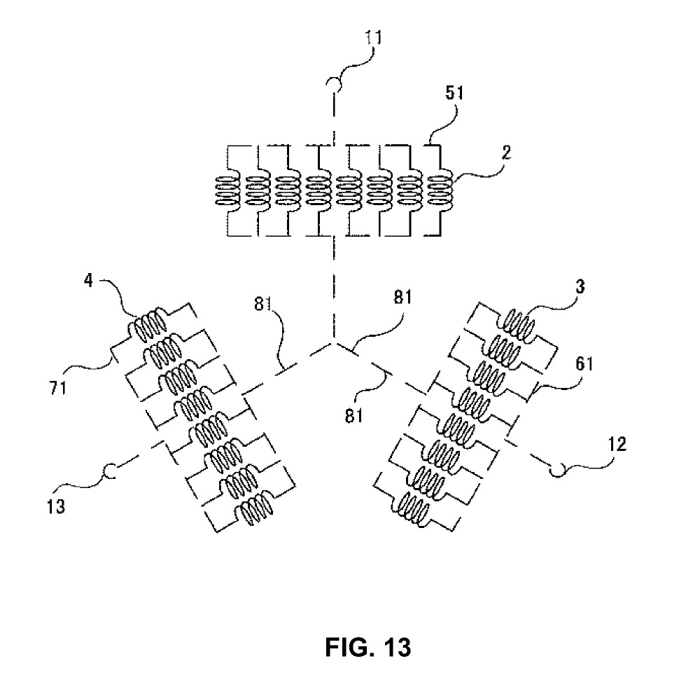

That is, the bus bar 10 of the sixth aspect of the present invention is given by inserting the conductor material 11 on which the folded portion 12 is formed, into the insulating tube 16 as shown in FIGS. 11 and 12. Of course, the bus bar 10 may be given by inserting the conductor material 11 having a predetermined length into the insulating tube 16 first and then folding a predetermined portion of the conductor material 11 together with the insulating tube 16 as described above to thereby form the folded portion 12.

The insulating tube 16 literally has insulation properties and is configured to envelop the internal conductor material 11 while securing insulation between the conductor material 11 and the peripheral parts. Of course, a hole for insertion of the terminal 21 can be formed in the insulating tube 16 by a physical impact such as heat so that the terminal 21 can be easily inserted to the folded portion 12 through this hole. The insulating tube 16 in the later-described embodiment shrinks as being heated and can envelop the conductor material 11 having the folded portion 12 formed thereon with almost no space therebetween so that the terminal 21 and the folded portion 12 can be electrically connected to each other from the outside, as shown in FIG. 11.

In an example shown in FIG. 11, the hole for connection of the terminal 21 and the electric connection portions between the terminal 21 and the folded portion 12 may be sealed with a potting resin 16a in some cases. The potting resin 16a can be used to keep inside of the insulating tube 16 in almost hermetically sealed condition, to shut off the inside as well as the insulating tube 16 itself from oxygen in the ambient air and humidity from the outside, thereby enhancing anti-rust effects of the conductor material 11.

The conductor material 11 enveloped in such an insulating tube 16 is securely insulated electrically from the peripheral parts by the insulating tube 16, so that the need of holding the conductor material 11 by the insulating holder 14 is eliminated, that is, the insulating holder 14 itself is rendered unnecessary. Accordingly, the bus bar 10 and the terminals 21 can be interconnected directly as shown in FIG. 12, to assemble the motor more easily.

Of course, as described above, the insulating tube 16 not only secures electrical insulation from the periphery but also protects the conductor material 11 from oxygen in the ambient air as well as humidity and water, which are responsible for rust, thereby enhancing decay durability of the bus bar 10.

Therefore, besides almost the same functions as those of the first to fifth aspects of the present invention, the bus bar 10 of the sixth aspect of the present invention has a function to protect the conductor material 11 by using the insulating tube 16 and, therefore, is more improved in decay durability.

To solve the problems, means employed by an invention according to a seventh aspect of the present invention is the bus bar 10 for use in the electric motor according to any of the first to sixth aspects of the present invention, in which “the bus bar 10 comprises one set of 4 kinds of bus bars: a U-phase bus bar, a V-phase bus bar, a W-phase bus bar, and a neutral-phase bus bar”.

The bus bar 10 of the seventh aspect of the present invention is suitable for use in a case where the electric motor is a 3-phase AC electric motor, comprising one set of 4 kinds of bus bars: a U-phase bus bar, a V-phase bus bar, a W-phase bus bar, and a neutral-phase bus bar. As shown in FIG. 13 illustrating the conventional example, the 3-phase AC electric motor has parallel connection of a plurality of the coils 20 corresponding to the U-phase, the V-phase and the W-phase, in which the terminals 21 of each of the coils are connected to the U-phase bus bar, the V-phase bus bar, and the W-phase bus bar on one end. The other end of the terminal 21 of each coil 20 is connected to the neutral-phase bus bar.

In the 3-phase AC electric motor having such U-phase, V-phase, W-phase, and neutral phase, the U-phase bus bar, the V-phase bus bar, and W-phase bus bar are supplied with AC power levels having changed “phases” and connected to the ground by the neutral-phase bus bar.

The bus bar 10 comprising one set of the 4 kinds of bus bars of the U-phase bus bar, the V-phase bus bar, the W-phase bus bar, and the neutral-phase bus bar has all the functions described in the inventions according to the first to fifth aspects of the present invention and therefore, of course, can itself be manufactured easily and enables manufacturing the 3-phase AC electric motor easily and inexpensively by using the bus bar 10 itself as a part of this motor.

Therefore, besides almost the same functions as those of the inventions according to the first to sixth aspects of the present invention, the bus bar 10 according to the seventh aspect of the present invention enables manufacturing the 3-phase AC electric motor easily and inexpensively.

As described above, a main feature of the present invention in structure is “a bus bar 10 configured to supply power to the plurality of coils 20 of an electric motor and/or ground the coils 20 in assemblage, in which a plurality of folded portions 12 each of which includes 3 or a larger odd number of overlapping portions 12a are formed on a conductor material 11 having a predetermined length so that at least a terminal 21 of each of the coils 20 can be electrically and directly fixed to a predetermined position of each of the folded portions 12”, so that it is possible to provide the bus bar 10 that can itself be manufactured easily as a part of the electric motor and enables manufacturing the electric motor also easily and inexpensively.

Further, the present invention enables electrically and directly connecting at least the terminal 21 of each of the coils 20 to a predetermined position of each of the folded portions 12 so that the terminal 21 on the side of the coil 20 can be directly and electrically connected and can provide the bus bar 10 that enables manufacturing an electric motor easily and inexpensively while stabilizing the relevant electrical connection portions always, to inhibit occurrence of problems of disconnection and peel-off.

Referring now to the figures, FIG. 1 shows a state where a bus bar 10 according to the present invention is incorporated into an insulating holder 14 having a hold groove 14a such as that shown in FIG. 2 and the insulating holder 14 is about to be attached to a housing of an electric motor. Each of coils 20 shown in FIG. 1 has its winding wire end as a terminal 21 projecting upward above the housing so that the terminal 21 may be electrically and directly connected to each bus bar 10 as shown in FIG. 2. In FIG. 2, only the terminals 21 to be connected to each bus bar 10 are denoted by a two-dot-and-dash line.

FIG. 3 shows a state where the bus bar 10 according to the present invention is contained in a mold resin 15 such as that shown in FIG. 4 by molding and the mold resin 15 is about to be attached to the housing of the electric motor. Each coil 20 shown in FIG. 3 also has its winding wire end as the terminal 21 projecting upward above the housing so that the terminal 21 can be electrically and directly connected to each bus bar 10 as shown in FIG. 4. In FIG. 4 also, only the terminals to be connected to each bus bar 10 are denoted by a two-dot-and-dash line.

The electric motors shown in FIGS. 1 and 3 are so-called “3-phase AC electric motors” and each comprise a U-phase coil 20, a V-phase coil 20, and a W-phase coil 20 as shown in FIG. 13 explaining a technology of Patent Document 1. The U-phase coil 20, the V-phase coil 20, and the W-phase coil 20 as well as a neutral phase are electrically connected to their respective bus bars, as which 4 kinds of bus bars, the bus bar 10 according to the present invention is employed.

Such a 3-phase AC electric motor uses various numbers of the coils 20, which numbers are, of course, a multiple of 3 because naturally the coil is necessary for each of the U-phase, the V-phase, and the W-phase.

A description will be given of characteristics of the bus bar 10 according to the present invention for each of Embodiment 1 shown in FIG. 5, Embodiment 2 shown in FIGS. 6 to 8, Embodiment 3 shown in FIG. 9, and Embodiment 4 shown in FIGS. 10 and 11.

As to Embodiment 1, a bus bar 10 according to Embodiment 1 shown in FIG. 5 is formed by using a wire rod such as that shown in FIG. 10(a) as a conductor material 11, along which conductor material 11a predetermined number of folded portions 12 are formed to be electrically connected to coils 20 or the ground. Of course, after the folded portions 12 are formed, the bus bar 10 is further bent into a circular ring as a whole to match the contour of the plurality of coils 20 arranged in a circle, two ends of which circular ring are separated from each other.

In the bus bar 10 according to Embodiment 1, the folded portion 12 includes a plurality of overlapping portions 12a formed by repeatedly folding back the conductor material 11 at a position thereof, as shown in FIGS. 5(a) and (b). The overlapping portions 12a are portions formed by simply folding back the conductor material 11 and, therefore, not fixed to each other, though they overlap with each other. That is, the folded portions 12 and the bus bar 10 including them are formed sequentially following one elongated insulating film 11a in an extending direction thereof. The conductor material 11 is plastically deformed at its portion beyond an elastic limit point or yield point where it is folded completely (the conductor material 11 is bent at 180° and, at the other portions, elastically deformed.

That is, in a case shown in FIG. 5, to make up the folded portion 12, at least 3 of the overlapping portions 12a are required in the length direction of the conductor material 11: the forward traveling first overlapping portion 12a, the backward traveling next overlapping portion 12a, and the originally-directional traveling overlapping portion 12a. Subsequently, 2 of the overlapping portions 12a can be added: the forward traveling overlapping portion 12a and the backward traveling overlapping portion 12a.

Accordingly, as shown in FIG. 5(b), by applying opposite-directional forces to the respective two sides of the folded portion 12 where the mutually overlapping portions 12a are formed, a gap occurs where the overlapping portions 12a are not plastically deformed and can be used as an insertion space which can be used to connect the terminals 21 of the coils 20 electrically and directly. However, when the opposite-directional forces are removed, the gap disappears because the conductor material 11, which is made of metal, is elastically deformed back to its original state by its own elastic force, as shown in FIG. 5(a).

The fact that the overlapping portions 12a of the folded portion 12 can each be elastically deformed means that the overlapping portions 12a where the terminals 21 of the coils 20 are not fixed to each other absorb vibrations received from, for example, a vehicle and, after absorption, immediately recover to their original positions. Therefore, the folded portions 12 itself of the bus bar 10 can each exert a “vibration absorbing function” for preventing disconnection and peel-off from occurring at the electric connection portions of the terminals 21 of the coils 20.

In the bus bar 10 according to Embodiment 1 shown in FIG. 5, each folded portion 12 is made up of the overlapping 3-layer portions 12a; however, the number of the layers of the overlapping portions 12a may be 5 as shown in FIG. 8. Of course, the number of the layers of the overlapping portions 12a may be 7 or a larger odd number as far as a space can be reserved to store the folded portions 12 or the folded portions 12 of the plurality of bus bars 10 can be isolated from each other.

The conductor material 11 used to sequentially form such bus bars 10 is a wire rod or elongated round wire rod shown in FIG. 10(a) as described above, however the conductor material 11 may be an “unprocessed material” of metal excellent in electric conductivity such as copper or a material coated with the insulating film 11a such as that shown in FIG. 10(c). The bus bar 10, even if having employed an unprocessed material of metal as the conductor material, has no trouble on insulation properties thereof because the bus bar 10 is held by an insulating holder 14 as shown in FIG. 1 or contained in a mold resin 15 by molding as shown in FIG. 3.

When the bus bar 10 is manufactured using the conductor material 11 having the insulating film 11a, despite the tendency of the conductor material 11 having the insulating film 11a to be expensive, of course, this bus bar 10 exerts great effects in all phases of its manufacture and assembly as well as completion and use of an electric motor owing to cooperation of insulation properties of the insulating film 11a itself and those of the insulating holder 14 or the mold resin 15.

FIGS. 6 to 8 show Embodiment 2 of a bus bar 10 according to the present invention. Embodiment 2 is different in the first place from Embodiment 1 in that Embodiment 2 has employed a flat material shown in FIG. 10(b) or a flat block shown in FIG. 10(c) as a conductor material 11.

Because the bus bar 10 of Embodiment 2 has employed the flat material shown in FIG. 10(b) or the flat block shown in FIG. 10(c) as the conductor material 11, a different construction is given in which a plurality of folded portions 12 are formed along the conductor material 11. Different from the wire rod such as that shown in FIG. 10(a), the flat material or the flat block in this case has a demerit in that it is very hard to be bent in a thickness direction thereof, but has a merit in that the flat material or the flat block can easily be electrically connected directly and has lower impedance during energization than the wire rod, owing to having a sufficient area.

Such a flat material or flat block needs to have a width-to-thickness ratio of 2:1 to 20:1 because if this ratio is less than 2:1, it is like a wire rod and does not have sufficient merits as a flat material. If the ratio is larger than 20:1, such a flat material or flat block is like a flat plate and needs to have a larger sized processing machine in order to cut off excess thereof and form the folded portions 12 and does not have sufficient merits as a flat material in this case either.

By forming the bus bar 10 overall by using the conductor material 11 that is such a flat material or flat block, it becomes easy to bend the bus bar 10 in a width direction thereof, that is, form the folded portions 12 or form the bus bar 10 in an annular shape. In particular, the overlapping portions 12a of each folded portion 12 can be easily folded at a width-directional kinked line of the conductor material 11 to form each folded portion 12 very stably. In the case of folding the flat material or flat block in the width direction and a length direction thereof, the width-directional kinked line does not obliquely face the width direction but naturally faces a direction parallel to the width direction, that is, faces a direction orthogonal to the length direction. In other words, when the conductor material 11 is folded, the resultant kinked line faces a direction in which the conductor material 11 can be bent most easily, that is, a direction orthogonal to the length direction.

When the conductor material 11 is folded at the width-directional kinked line thereof, that is, a kinked line orthogonal to the length direction thereof as described above, the overlapping portions 12a of the folded portion 12 overlap with each other literally completely as shown in FIGS. 6 to 8, and 9. In other words, by forming the bus bar 10 by folding the conductor material 11 at the width-directional kinked line thereof, the bus bar 10 has almost the same width-directional size as that of the original conductor material 11, to remain narrow in a manner.

The second respect of the bus bar 10 according to Embodiment 2 different from that according to Embodiment 1 is that as shown in FIG. 6, for example, an insertion space 12b is formed in at least one of the odd number of overlapping portions 12a in which the terminal 21 of the coil 20 can be inserted. As denoted by an arrow in FIG. 6, the insertion space 12b is arranged to enable inserting the terminal 21 of the coil 20 thereinto; the presence of such an insertion space 12b enables carrying out connection work more easily because the insertion space 12b eliminates the need of purposely forming the gap such as that shown in FIG. 5(b) at each of the folded portions 12.

The insertion space 12b can be easily formed by forming a portion corresponding to the insertion space 12b at a portion of a mold used to bend and form each of the overlapping portions 12a of the folded portion 12, without using a large-scale technology in particular. The insertion space 12b of the embodiment shown in FIGS. 6 and 7 is shaped to be most suitable for a case where the terminal 21 on the side of the coil 20 is a “rectangular wire”, that is, in a shape to match the traverse cross-sectional shape of the rectangular wire.

A bus bar 10 according to Embodiment 3 shown in FIG. 9 is different from those of Embodiments 1 and 2 in that at least one twisted portion 13 is formed on a conductor material 11 between folded portions 12.

Of course, the twisting angle of each of the twisted portions 13 is selected appropriately; however, naturally the angle is not 180° or more because the twisted portion 13 is used to change the direction of the insertion space in order to facilitate insertion of the terminal 21 into the insertion space in each folded portion 12. Of course, the angle may be large enough if it is 90° at the maximum because the insertion space in each folded portion 12 is open at both ends. In view of the above, the twisting angle of each twisted portion 13 is determined in a range between 20° and 80° in many cases.

By forming the twisted portion 13, the opening direction of the insertion space in one of the two folded portions 12 adjacent to this twisted portion 13 on both sides thereof is changed with respect to that of the insertion space in the other folded portion 12 adjacent to this twisted portion 13 by an angle at which the portion is twisted. The directions of the insertion spaces in the two folded portions 12 adjacent to the one twisted portion 13 on both the sides thereof are changed from each other in order to facilitate work of inserting the terminals 21 of coils 20 in the following cases.

The terminal 21 of each of the coils 20, which is pulled out toward the bus bar 10 as shown in FIGS. 1 and 3, is each inserted into the insertion space in each of the folded portions 12 of the bus bar 10 according to the present invention, no matter whether it is just the space such as that shown in FIG. 5(b) or the insertion space 12b formed actively such as that shown in FIG. 6, etc., and then electrically connected by spot welding, etc.,; however, the direction of which insertion space may not match the direction of each terminal 21 of the coil 20 in some cases. Further, in some cases, the wire rod of the terminal 21 of the coil 20 may have a limitation in bending direction as in the case of the “rectangular wire” described above. To accommodate those cases, the direction of the insertion space in one of the two folded portions 12 and that of the insertion space in the other folded portion 12 are changed from each other via the twisted portion 13.

A bus bar 10 according to Embodiment 4 shown in FIGS. 11 and 12 is given by inserting a conductor material 11 having a folded portion 12 formed thereon into an insulating tube 16. Of course, the bus bar 10 may be given by inserting the conductor material 11 having a predetermined length into the insulating tube 16 first and then folding a predetermined portion of the conductor material 11 together with the insulating tube 16 as described above to thereby form the folded portion 12.

The insulating tube 16 literally has insulation properties and is configured to envelop the internal conductor material 11 while securing insulation between the conductor material 11 and the peripheral parts. Of course, a hole for insertion of the terminal 21 can be formed in the insulating tube 16 by a physical impact such as heat so that the terminal 21 can be easily inserted to the folded portion 12 through this hole. Further, the insulating tube 16 shrinks as being heated and can envelop the conductor material 11 having the folded portion 12 formed thereon with almost no space in between so that the terminal 21 and the folded portion 12 can be electrically connected to each other from the outside, as shown in FIG. 11.

As shown in FIG. 11, the hole for connection of the terminal 21 and the electric connection portions between the terminal 21 and the folded portion 12 are sealed with a potting resin 16a. The potting resin 16a can be used to keep inside of the insulating tube 16 in almost hermetically sealed condition, to shut off the inside as well as the insulating tube 16 itself from oxygen in the ambient air and humidity from the outside, thereby enhancing anti-rust effects of the conductor material 11.

The conductor material 11 enveloped in such an insulating tube 16 is securely insulated electrically from the peripheral parts by the insulating tube 16, so that the need of holding the conductor material 11 by the insulating holder 14 is eliminated, that is, the insulating holder 14 itself is rendered unnecessary. Accordingly, the bus bar 10 and the terminals 21 can be interconnected directly as shown in FIG. 12, to assemble the motor more easily.

Of course, the insulating tube 16 not only secures electrical insulation from the periphery but also protects the conductor material 11 from oxygen in the ambient air as well as humidity and water, which are responsible for rust, thereby enhancing decay durability of the bus bar 10.

In the bus bar 10 according to the present invention, the folded portion 12 that replaces a “tab” separately formed conventionally is formed by folding the conductor material 11 itself, so that this bus bar can be applied as a “bus line” in the case of, for example, electrically interconnecting various electric apparatuses at the same potential. Besides, the bus bar 10 can be formed by sequentially folding the conductor material 11 made of a round wire rod, flat material, or flat block and, therefore, can be mounted in a very small space and inexpensively. Accordingly, the bus bar has large applicability not only in the electric motors but also in other fields of, for example, manufacturing electric appliances such as refrigerators and washing machines.

The following reference numerals are used in this description:

10: Bus bar

11: Conductor material

11a: Insulating film

12: Folded portion

12a: Overlapping portion

12b: Insertion space

13: Twisted portion

14: Insulating holder

14a: Hold groove

15: Mold resin

16: Insulating tube

16a: Potting resin

20: Coil

21: Terminal

Note that in the specification and claims, “about” or “approximately” means within twenty percent (20%) of the numerical amount cited. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A bus bar for use in an electric motor configured to supply power to a plurality of coils of the electric motor and/or ground the coils in assemblage, wherein a plurality of folded portions each of which includes three or a larger odd number of overlapping portions are formed on a conductor material having a predetermined length so that at least a terminal of each of the coils can be electrically and directly fixed to a predetermined position of each of the folded portions.

2. The bus bar for use in an electric motor according to claim 1, wherein an insertion space in which the terminal of the coil can be inserted is formed in at least one of the odd number of overlapping portions.

3. The bus bar for use in an electric motor according to claim 2, wherein at least one twisted portion is formed on the conductor material between the folded portions and an opening direction of the insertion space in one of the two folded portions adjacent to this twisted portion on both sides is changed with respect to that of the insertion space in the other folded portion adjacent to this twisted portion.

4. The bus bar for use in an electric motor according to claim 1, wherein the conductor material is a flat material having a width-to-thickness ratio of 2:1 to 20:1 and each of the overlapping portions is given by folding this flat material at a width-directional kinked line thereof.

5. The bus bar for use in an electric motor according to claim 1, wherein the conductor material is a flat block on a surface of which an insulating film is formed.

6. The bus bar for use in an electric motor according to claim 1, wherein the conductor material on which the folded portion is formed is inserted into an insulating tube.

7. The bus bar for use in an electric motor according to claim 1, comprising one set of four kinds of bus bars: a U-phase bus bar, a V-phase bus bar, a W-phase bus bar, and a neutral-phase bus bar.
